(19) United States
(12) Patent Application Publication
(10) Pub. No.: US 2014/0264141 A1
(43) Pub. Date: Sep. 18, 2014

(54) INSULATING FILM

(71) Applicants: Shunsuke Masaki, Ibaraki-shi (JP); Toshimasa Nishimori, Ibaraki-shi (JP); Hiroyuki Fujita, Ibaraki-shi (JP); Kazunori Hayashi, Sakai-shi (JP); Jun Fujiki, Sakai-shi (JP)

(72) Inventors: Shunsuke Masaki, Ibaraki-shi (JP); Toshimasa Nishimori, Ibaraki-shi (JP); Hiroyuki Fujita, Ibaraki-shi (JP); Kazunori Hayashi, Sakai-shi (JP); Jun Fujiki, Sakai-shi (JP)

(73) Assignee: NITTO DENKO CORPORATION, Ibaraki-shi, Osaka (JP)

(21) Appl. No.: 14/239,727

(22) PCT Filed: Jun. 29, 2012
(86) PCT No.: PCT/JP2012/066733

§ 371 Date: Jun. 2, 2014

(30) Foreign Application Priority Data
Aug. 25, 2011 (JP) 2011-183335
May 28, 2012 (JP) 2012-120614

(51) Int. Cl. H01B 3/30

(52) U.S. Cl. CPC H01B 3/305
USPC 252/62

(57) ABSTRACT

Provided is an insulating film which can be produced easily at low cost and which is excellent in discharge deterioration resistance and mechanical characteristics. The insulating film includes a polyamide imide resin having a weight average molecular weight of 35,000 to 75,000 and an insulating fine particle having an average primary particle diameter of 200 nm or less.

### TECHNICAL FIELD

The present invention relates to an insulating film excellent in mechanical characteristics and discharge deterioration resistance.

### BACKGROUND ART

In recent years, a voltage to be used has tended to increase in, for example, automobile motors, industrial motors, and inverters for large equipment, and hence there has been a demand for high heat resistance and voltage resistance in an insulating material to be used in those motors and inverters.

The voltage resistance of the insulating material is degraded with the passage of time owing to the influence of heat deterioration and discharge deterioration. Specifically, regarding the discharge deterioration, when a defect such as a small void, crack, or flaw is present in the insulating material, weak discharge, that is, partial discharge (corona discharge) is caused in the defect by the application of a voltage. It is considered that, when the partial discharge is repeated, local breakdown occurs, which is gradually developed in a dendritic pattern, finally resulting in dielectric breakdown. Further, a dendritic breakdown mark in this case is called an electrical tree.

As a countermeasure against the discharge deterioration, there is known an insulating coating containing a resin and insulating fine particles dispersed in the resin (Patent Literature 1). An insulating electric wire covered with such insulating coating exhibits excellent resistance to discharge deterioration because the insulating fine particles suppress the development of an electrical tree in the covering layer.

As with the insulating coating, when an insulating film containing a resin and insulating fine particles dispersed in the resin is considered, there is a problem in that the film becomes brittle by the addition of a filler in the case where a polyamide imide resin is used as the resin contained in the insulating film. Therefore, the following have been proposed: a film having sufficient mechanical characteristics is obtained through use of a silane-modified polyamide imide resin in which siloxane is introduced into terminal carboxylic acid, in place of adding a filler (silane compound) to a polyamide imide resin (Patent Literature 2) and an insulating material having resistance to discharge (corona) deterioration is obtained by adding inorganic fine particles to the silane-modified polyamide imide resin (Non Patent Literature 1).

However, the silane-modified polyamide imide resin takes labor and cost for its preparation, compared to a general polyamide imide resin. Therefore, there is a demand for an insulating film which can be produced more easily at lower cost and which is excellent in discharge deterioration resistance and mechanical characteristics.

### CITATION LIST

### Patent Literature

[PTL 1] JP 3496636 B2
[PTL 2] JP 2001-240670 A

### Non Patent Literature

[NPL 1] Furukawa Electric Review, No. 110, p. 33 to 36

### SUMMARY OF INVENTION

### Technical Problem

The present invention has been made in view of solving the above-described problems, and an object of the present invention is to provide an insulating film which can be produced easily at low cost and which is excellent in discharge deterioration resistance and mechanical characteristics.

### Solution to Problem

The inventors of the present invention have earnestly studied, and consequently found that a polyamide imide resin having a general structure can also achieve the above-mentioned object when used in combination with insulating fine particles each having an average particle diameter of a predetermined value or less, as long as the polyamide imide resin has a weight average molecular weight in a particular range. Thus, the inventors have achieved the present invention.

An insulating film of the present invention includes: a polyamide imide resin having a weight average molecular weight of 35,000 to 75,000; and an insulating fine particle having an average primary particle diameter of 200 nm or less.

In a preferred embodiment, in the insulating fine particle contains at least one component selected from silica, alumina, titania, and a layered silicate (clay).

In a preferred embodiment, in the insulating film, the content of the insulating fine particle is 1 to 20 parts by weight with respect to 100 parts by weight of the polyamide imide resin.

### Advantageous Effects of Invention

According to one embodiment of the present invention, a polyamide imide resin having a general structure can be used, and hence an insulating film excellent in discharge deterioration resistance and mechanical characteristics can be obtained easily at low cost.

### BRIEF DESCRIPTION OF DRAWINGS

FIG. 1 is a schematic diagram of a circuit in measurement of an insulation life time.

FIG. 2 is a schematic view illustrating an electrode arrangement in measurement of an insulation life time.

### DESCRIPTION OF EMBODIMENTS

[Insulating Film]

An insulating film of the present invention includes a polyamide imide resin having a weight average molecular weight of 35,000 to 75,000 and insulating fine particles each having an average primary particle diameter of 200 nm or less. The thickness of the insulating film of the present invention is preferably 10 μm to 150 μm.

[Polyamide Imide Resin]

The polyamide imide resin is a resin having a rigid imide group and an amide group imparting flexibility in a molecular skeleton. The insulating film of the present invention can exhibit excellent heat resistance, mechanical characteristics, insulating property, and the like through use of such polyamide imide resin. As the polyamide imide resin to be used in the present invention, one having a generally known structure can be used.

The weight average molecular weight of the polyamide imide resin is 35,000 to 75,000, preferably 40,000 to 75,000, more preferably 50,000 to 70,000, still more preferably 55,000 to 67,000. When the weight average molecular weight is less than 35,000, the mechanical characteristics of a film to be obtained become insufficient. Further, when the weight average molecular weight is more than 75,000, the viscosity increases, which may degrade workability and dispersibility of the insulating fine particles in some cases.

The polyamide imide resin can be obtained by any appropriate synthesis method. Examples thereof include an acid chloride method involving subjecting trimellitic anhydride chloride and a diamine to a reaction, an isocyanate method involving subjecting trimellitic anhydride and a diisocyanate to a reaction, and a direct polymerization method involving subjecting trimellitic anhydride and a diamine to a reaction. Of those, an isocyanate method is preferred from the viewpoint of excellence in work efficiency.

Examples of the diisocyanate to be used in the case where the isocyanate method is adopted include: aromatic diisocyanates such as diphenylmethane diisocyanate, tolylene diisocyanate, tetramethylxylene diisocyanate, and 3,3′-dimethylbiphenyl-4,4′-diisocyanate; aliphatic diisocyanates such as ethylene diisocyanate, propylene diisocyanate, and hexamethylene diisocyanate; and alicyclic diisocyanates such as isophorone diisocyanate, hydrogenated xylylene diisocyanate, norbornene diisocyanate, and dicyclohexylmethane diisocyanate. Of those, diphenylmethane diisocyanate and dicyclohexylmethane diisocyanate are preferred from the viewpoint of excellence in cost.

The reaction between trimellitic anhydride and the diisocyanate may be performed in any appropriate solvent. Examples of the solvent include N-methyl-2-pyrrolidinone, N,N-dimethylacetamide, and γ-butyrolactone. Those solvents may be used alone or in combination.

In the reaction, a catalyst may be used as required. Any appropriate catalyst may be used as the catalyst, and examples thereof include diazabicycloundecene, triethylenediamine, potassium fluoride, and cesium fluoride.

The reaction temperature and reaction time can be set appropriately depending on purposes and the like. For example, the reaction temperature can be 120 to 250° C., and the reaction time can be 4 to 20 hours. The reaction temperature may be constant or changed in stages.

[Insulating Fine Particles]

The insulating fine particles are present so as to be dispersed in the polyamide imide resin and thereby suppress the development of an electrical tree in discharge deterioration of the insulating film. As a result, discharge deterioration is also suppressed, and hence, a period of time required for the film to be subjected to dielectric breakdown (also referred to as “insulation life time”) can be extended.

The average primary particle diameter of each of the insulating fine particles is 200 nm or less, preferably 3 to 150 nm, more preferably 5 to 100 nm, still more preferably 8 to 50 nm. When the average primary particle diameter is more than 200 nm, the effect of suppressing the development of an electrical tree is degraded, and a sufficient insulation life time may not be obtained in some cases. Herein, the average primary particle diameter can be obtained by measuring the major axes of 50 primary particles of the insulating fine particles and calculating an average value thereof in an image of a film cross-section obtained by transmission electron microscope observation.

A material for forming the insulating fine particles is not particularly limited, and examples of the material include silica, alumina, titania, boron nitride, magnesium hydroxide, aluminum hydroxide, and a layered silicate (clay). Of those, silica, alumina, titania, and a layered silicate (clay) may be preferably used from the viewpoint of excellence in dispersibility and insulating property. For example, fumed silica or colloidal silica may be preferably used as the silica.

As the insulating fine particles, ones having various particle diameters are commercially available, and hence can be selected and used depending on purposes. The insulating fine particles may be subjected to any appropriate surface treatment as needed. Examples of the surface treatment include the introduction of an amino group using an aminosilane compound and hydrophobization using trimethylsilane or the like. The surface treatments may be performed alone or in combination.

The content of the insulating fine particles in the insulating film of the present invention is preferably 1 to 20 parts by weight, more preferably 2 to 15 parts by weight, still more preferably 3 to 10 parts by weight with respect to 100 parts by weight of the resin solid content of the polyamide imide resin. When the content falls within such range, an insulating film excellent in mechanical characteristics and insulation life can be obtained.

[Production Method for Insulating Film]

The insulating film of the present invention can be produced typically by: adding the insulating fine particles to varnish of the polyamide imide resin to disperse the insulating fine particles therein; applying the obtained varnish in which the insulating fine particles are dispersed onto a substrate, followed by drying the varnish; and releasing the dried film thus obtained (sometimes referred to as “semi-cured film”) from the substrate, followed by curing the film by heating.

The resin concentration of the varnish of the polyamide imide resin can be set to any appropriate value depending on purposes and the like. The resin concentration is generally 10 to 40% by weight. As each of a dispersion method for the insulating fine particles and an application method for the varnish in which the insulating fine particles are dispersed, any appropriate method can be adopted.

The drying temperature and time of the varnish in which the insulating fine particles are dispersed can be set appropriately depending on application thickness and the like. For example, the drying temperature can be 50° C. to 200° C. Further, the drying time can be 10 minutes to 60 minutes. The drying temperature may be constant or changed in stages.

The heat-curing temperature and time of the dried film can be set appropriately depending on the thickness of the dried film and the like. For example, the curing temperature can be 250° C. to 400° C. Further, the curing time can be 5 minutes to 60 minutes. When the dried film is cured by heating, it is preferred that the film be fixed so as not to shrink.

### EXAMPLES

Hereinafter, the present invention is described specifically by way of Examples. However, the present invention is by no means limited to Examples below. Note that measurement methods in Examples and the like are as follows.

(1) Weight Average Molecular Weight

The weight average molecular weight was measured in terms of polyethylene oxide (PEO) through use of gel permeation chromatography (GPC). GPC conditions are as follows.

GPC device: Product name “HLC-8120GPC” (produced by Tosoh Corporation)

Column: “TSKgel superAWM-H”+“TSKgel superAW4000”+“TSKgel superAW2500” (produced by Tosoh Corporation)

Flow rate: 0.4 ml/min

Concentration: 1.0 g/l

Injection amount: 20 μl

Column temperature: 40° C.

Eluent: 10 mM LiBr+10 mM phosphoric acid/DMF

(2) Tensile Strength and Elongation (%)

A film having a thickness of 50 μm punched into a dumbbell-like No. 3 type was used as a sample. The sample was stretched at a tension speed of 100 mm/min through use of a tensilon universal testing machine (produced by Toyo Baldwin Co., Ltd.) to obtain tensile strength and elongation (%) (=(Length at break−Original length)/Original length×100) at a time when the sample was broken.

(3) Insulation Life Time

A period of time required for causing dielectric breakdown in a measurement sample at normal temperature and pressure was measured with an application voltage being set to an AC voltage of 3 kV through use of a breakdown voltage tester (product name “5051A”, produced by Tsuruga Electric Corporation). FIGS. 1 and 2 respectively illustrate a measurement circuit and an electrode arrangement. Twenty points on the measurement sample were measured and thereafter a Weibull distribution of breakdown time was created. A period of time required for a cumulative occurrence probability to reach 63.2% was defined as an average insulation life time.

(4) Average Primary Particle Diameter

A film cross-section was observed at an acceleration voltage of 100 kV through use of a transmission electron microscope (product No. “H-7650”, produced by Hitachi High-Technologies Corporation). The major axes of 50 primary particles of insulating fine particles were measured on the basis of the obtained observed image, and an average value thereof was defined as an average primary particle diameter.

(5) Viscosity of Varnish

The viscosity of varnish at 25° C. was evaluated through use of a digital viscometer HBDV-I Prime (produced by Brookfield Engineering Laboratories, Inc.).

### Synthesis Example 1

To a four-necked flask equipped with a mechanical stirrer having a stirring blade, 1.00 mol of trimellitic anhydride (TMA), 1.00 mol of diphenylmethane diisocyanate (MDI), and 1,063 g of N-methyl-2-pyrrolidinone (NMP) were supplied, and the mixture was reacted at 120° C. for 2 hours. After that, the temperature of the mixture was raised to 180° C. and the mixture was further reacted at 180° C. for 3 hours. Consequently, polyamide imide varnish was obtained. The weight average molecular weight of the obtained polyamide imide resin was 65,500.

### Synthesis Example 2

Polyamide imide varnish was obtained in the same way as in Synthesis Example 1 except for setting the reaction time to 3 hours at 120° C. The weight average molecular weight of the obtained polyamide imide resin was 33,700.

### Synthesis Example 3

Polyamide imide varnish was obtained in the same way as in Synthesis Example 1 except for setting the reaction time to 1.5 hours at 120° C. The weight average molecular weight of the obtained polyamide imide resin was 9,410.

### Synthesis Example 4

Polyamide imide varnish was obtained in the same way as in Synthesis Example 1 except for setting the reaction time to 2 hours at 120° C. and then 2 hours at 180° C. The weight average molecular weight of the obtained polyamide imide resin was 58,800.

### Synthesis Example 5

Polyamide imide varnish was obtained in the same way as in Synthesis Example 1 except for setting the reaction time to 2 hours at 120° C. and then 5 hours at 180° C. The weight average molecular weight of the obtained polyamide imide resin was 76,400.

The resin solid content of the polyamide imide varnish obtained in Synthesis Examples 1 to 5 was adjusted to 25% by weight, and the viscosity of the varnish (solvent:NMP) after the adjustment was measured. Table 1 shows the results.

TABLE 1

| | Synthesis | Synthesis | Synthesis | Synthesis | Synthesis |
|---|---|---|---|---|---|
| | Example 1 | Example 2 | Example 3 | Example 4 | Example 5 |
| Weight | 65,500 | 33,700 | 9,410 | 58,800 | 76,400 |
| average | | | | | |
| molecular | | | | | |
| weight | | | | | |
| Varnish | 66.4 | 29.8 | 0.350 | 55.2 | 171 |
| viscosity | | | | | |
| [Pa · s] | | | | | |

### Example 1

Nanosilica (product name “AEROSIL™RA200H”, produced by Nippon Aerosil Co., Ltd.) was added to the polyamide imide varnish of Synthesis Example 1 so that a filler amount with respect to the resin solid content became 5 parts by weight and dispersed in the varnish with a bead mill. The obtained silica dispersion varnish was applied onto a glass substrate so as to have a thickness of 50 μm after being dried. The silica dispersion varnish was heated at 80° C. for 15 minutes and then at 150° C. for 15 minutes and cooled to room temperature. After that, the silica dispersion varnish was released from the glass substrate. Thus, an independent semi-cured film was obtained. The semi-cured film was further heated at 340° C. for 15 minutes with an end portion thereof being fixed, whereby a cured film of polyamide imide was obtained.

### Example 2

A cured film of polyamide imide was obtained in the same way as in Example 1 except for using silica (product name “AEROSIL™NA50H”, produced by Nippon Aerosil Co., Ltd.) as insulating fine particles.

### Example 3

A cured film of polyamide imide was obtained in the same way as in Example 1 except for using silica (product name “AEROSIL™RX200”, produced by Nippon Aerosil Co., Ltd.) as insulating fine particles.

### Example 4

A cured film of polyamide imide was obtained in the same way as in Example 1 except for using silica (product name “AEROSIL™200”, produced by Nippon Aerosil Co., Ltd.) as insulating fine particles.

### Example 5

A cured film of polyamide imide was obtained in the same way as in Example 1 except for using alumina (product name “AEROXIDE™AluC”, produced by Nippon Aerosil Co., Ltd.) as insulating fine particles.

### Example 6

A cured film of polyamide imide was obtained in the same way as in Example 1 except for using titania (product name “AEROXIDE™TiO₂ P90”, produced by Nippon Aerosil Co., Ltd.) as insulating fine particles.

### Example 7

A cured film of polyamide imide was obtained in the same way as in Example 1 except for using clay (product name “S-BEN NO-12S”, produced by HOJUN Co., Ltd.) as insulating fine particles.

### Example 8

A cured film of polyamide imide was obtained in the same way as in Example 1 except for using the polyamide imide varnish of Synthesis Example 4.

### Comparative Example 1

A cured film of polyamide imide was obtained in the same way as in Example 1 except for not adding nanosilica.

### Comparative Example 2

Silica dispersion varnish was prepared and applied onto a glass substrate in the same way as in Example 1 except for using the polyamide imide varnish of Synthesis Example 3. The silica dispersion varnish was heated at 80° C. for 15 minutes and then at 150° C. for 15 minutes, and cooled to room temperature. An attempt was made to release the silica dispersion polyamide imide resin on the glass substrate from the substrate but the silica dispersion polyamide imide resin was not able to be released as a film owing to its small elongation and brittleness.

### Comparative Example 3

Silica dispersion varnish was prepared and applied onto a glass substrate in the same way as in Example 1 except for using the polyamide imide varnish of Synthesis Example 2. The silica dispersion varnish was heated at 80° C. for 15 minutes and then at 150° C. for 15 minutes and cooled to room temperature. The silica dispersion polyamide imide resin on the glass substrate was released from the substrate to obtain a semi-cured film. At that time, the film was cracked.

### Comparative Example 4

A cured film of polyamide imide was obtained in the same way as in Example 1 except for using silica (product name “ADMAFINE SC1050-SXT”, produced by Admatechs) as insulating fine particles.

### Comparative Example 5

A cured film of polyamide imide was obtained in the same way as in Example 1 except for using the polyamide imide varnish of Synthesis Example 5.

The cured films and semi-cured films of polyamide imide obtained in Examples and Comparative Examples above were each measured for its tensile strength, elongation, and average insulation life time. Table 2 shows the results.

TABLE 2

| | | Example 1 | Example 2 | Example 3 | Example 4 | Example 5 | Example 6 | Example 7 | Example 8 |
|---|---|---|---|---|---|---|---|---|---|
| Polyamideimide | | Synthesis | Synthesis | Synthesis | Synthesis | Synthesis | Synthesis | Synthesis | Synthesis |
| | | Example 1 | Example 1 | Example 1 | Example 1 | Example 1 | Example 1 | Example 1 | Example 4 |
| | Mw | 65,500 | 65,500 | 65,500 | 65,500 | 65,500 | 65,500 | 65,500 | 58,800 |
| | (In terms of PEO) | | | | | | | | |
| Insulating | Kind | Fumed | Fumed | Fumed | Fumed | Fumed | Fumed | Organoclay | Fumed |
| fine | | silica | silica | silica | silica | alumina | titania | | silica |
| particles | Product name | RA200H | NA50H | RX200 | 200 | Alu C | TiO₂P90 | S-BEN | RA200H |
| | | | | | | | | NO-12S | |
| | Surface treatment | Trimethyl- | Trimethyl- | Trimethyl- | None | None | None | Quaternary | Trimethyl- |
| | | silane | silane | silane | | | | ammonium | silane |
| | | Aminosilane | Aminosilane | | | | | cation | Amino- |
| | | | | | | | | | silane |
| | Average primary | 12 | 30 | 12 | 12 | 13 | 14 | 133 | 12 |
| | particle diameter | | | | | | | | |
| | (nm) | | | | | | | | |
| | Addition amount | 5 | 5 | 5 | 5 | 5 | 5 | 5 | 5 |
| | (parts) | | | | | | | | |
| Semi-cured | Film formability*1 | ∘ | ∘ | ∘ | ∘ | ∘ | ∘ | ∘ | ∘ |
| film | Tensile strength | 96 | — | — | — | — | — | — | 106 |
| | (MPa) | | | | | | | | |
| | Elongation (%) | 75 | — | — | — | — | — | — | 67 |
| Cured film | Average insulation | 47.7 | 20.2 | 31.2 | 21.3 | 29.8 | 20.8 | 47.5 | 71.3 |
| | lifetime (h) | | | | | | | | |
| | Tensile strength | 147 | 135 | 135 | 140 | 141 | 138 | 124 | 147 |
| | (MPa) | | | | | | | | |
| | Elongation (%) | 13 | 15 | 13 | 14 | 14 | 13 | 10 | 12 |

| | | Comparative | Comparative | Comparative | Comparative | Comparative |
|---|---|---|---|---|---|---|
| | | Example 1 | Example 2 | Example 3 | Example 4 | Example 5 |
| Polyamideimide | | Synthesis | Synthesis | Synthesis | Synthesis | Synthesis |
| | | Example 1 | Example 3 | Example 2 | Example 1 | Example 5 |
| | Mw | 65,500 | 9,410 | 33,700 | 65,500 | 76,400 |
| | (In terms of PEO) | | | | | |
| Insulating | Kind | — | Fumed | Fumed | VMC | Fumed |
| fine | | | silica | silica | silica*2 | silica |
| particles | Product name | — | RA200H | RA200H | SC1050-SXT | RA200H |
| | Surface treatment | — | Trimethyl- | Trimethyl- | Aminophenyl | Trimethyl- |
| | | | silane | silane | silane | silane |
| | | | Aminosilane | Aminosilane | | Aminosilane |
| | Average primary | — | 12 | 12 | 205 | 12 |
| | particle diameter | | | | | |
| | (nm) | | | | | |
| | Addition amount | — | 5 | 5 | 5 | 5 |
| | (parts) | | | | | |
| Semi-cured | Film formability*1 | ∘ | x | Δ | ∘ | ∘ |
| film | Tensile strength | — | Un- | 59 | — | 101 |
| | (MPa) | | measurable | | | |
| | Elongation (%) | — | Un- | 33 | — | 72 |
| | | | measurable | | | |
| Cured film | Average insulation | 10.3 | — | Un- | 11.2 | 16.4 |
| | lifetime (h) | | | measurable | | |
| | Tensile strength | 147 | — | — | 142 | 150 |
| | (MPa) | | | | | |
| | Elongation (%) | 15 | — | — | 16 | 13 |

*1Film formability: the case where a semi-cured film can be released from a glass substrate is indicated by ∘; the case where cracking occurs during release is indicated by Δ; and the case where release is impossible is indicated by x.
*2Vaporized Metal Combustion

As shown in Table 2, the films of Examples 1 to 8 are excellent in mechanical characteristics and have average insulation life times longer than 20 hours. In contrast, the polyamide imide film of Comparative Example 1 had a short average insulation life time of about 10 hours owing to the absence of the insulating fine particles. In Comparative Example 2, the polyamide imide resin having a weight average molecular weight of 9,410 was used, and hence the semi-cured film had degraded mechanical characteristics to become brittle by the addition of the insulating fine particles. As a result, it was not possible to release the film from the substrate. In Comparative Example 3, the polyamide imide resin having a weight average molecular weight of 33,700 was used, and hence the semi-cured film had degraded mechanical characteristics to become brittle by the addition of the insulating fine particles. As a result, cracking occurred in the film during release. In Comparative Example 4, the particle diameter of each of the insulating fine particles was large, and hence the resistance to discharge deterioration was insufficient. In Comparative Example 5, the weight average molecular weight of the polyamide imide resin was large, and hence the dispersion defect of an insulating filler occurred, and the resistance to discharge deterioration was insufficient.

### INDUSTRIAL APPLICABILITY

The insulating film of the present invention can be preferably used in automobile motors, industrial motors, inverters for large equipment, and the like.

### REFERENCE SIGNS LIST

1 electrode
2 measurement sample (insulating film)
3 frame ground

1. An insulating film, comprising: a polyamide imide resin having a weight average molecular weight of 35,000 to 75,000; and an insulating fine particle having an average primary particle diameter of 200 nm or less.

2. An insulating film according to claim 1, wherein the insulating fine particle contains at least one component selected from silica, alumina, titania, and a layered silicate (clay).

3. An insulating film according to claim 1, wherein a content of the insulating fine particle is 1 to 20 parts by weight with respect to 100 parts by weight of the polyamide imide resin.
